(19) United States
(12) Patent Application Publication
(10) Pub. No.: US 2019/0286631 A1
(43) Pub. Date: Sep. 19, 2019

(54) ACCESSING PIPE IDENTIFICATION AND TRACKING SYSTEM

(71) Applicant: ULTRA PREMIUM SERVICES, L.L.C., Houston, TX (US)

(72) Inventors: Christopher Tu Tran, Houston, TX (US); Curtis Matthew Potts, Regina (CA)

(73) Assignee: ULTRA PREMIUM SERVICES, L.L.C., Houston, TX (US)

(21) Appl. No.: 16/402,755

(22) Filed: May 3, 2019

Related U.S. Application Data
(63) Continuation-in-part of application No. 16/163,050, filed on Oct. 17, 2018.
(60) Provisional application No. 62/573,490, filed on Oct. 17, 2017.

(51) Int. Cl. G06F 16/2455; G06F 16/248; G06K 7/10

(52) U.S. Cl. CPC G06F 16/2455; G06K 7/10366; G06F 16/248

(57) ABSTRACT

Techniques include systems and methods for accessing an identification and tracking system for tubular goods. One or more embodiments involve reading an identifier of a pipe, sending a query to a database to access pipe information associated with the identifier, and displaying pipe information based on the identifier, in response to the query. In some embodiments, reading the identifier includes reading an RFID tag on the pipe and displaying pipe information which may comprise pipe dimensions, pipe composition, pipe treatment details, pipe testing results, pipe order number, bill of lading number, pipe manufacturing location, pipe treatment location, pipe delivery destination, or combinations thereof.

### TECHNICAL FIELD

The present application relates to tracking systems, and more particularly, to identification and tracking systems for tubular goods.

### BACKGROUND

This section is intended to introduce various aspects of art that may be related to various aspects of the present techniques, which are described and/or claimed below. This discussion is believed to be helpful in providing background information to facilitate a better understanding of the various aspects of the present disclosure. Accordingly, it should be understood that these statements are to be read in this light, and not as admissions of prior art. The following descriptions and examples are not admitted to be prior art by virtue of their inclusion in this section.

The oil and gas industry is drilling upstream production wells of increasing depth and complexity to find and produce raw hydrocarbons. The industry routinely uses steel pipe, considered an Oil Country Tubular Good (OCTG) to protect the borehole (i.e., casing) and to control the fluids produced within the pipe (i.e., tubing). Such tubular goods, including casing and tubing, are made and transported in relatively short segments and installed in the borehole one segment at a time, with each segment being connected to the next.

Depending on the different environments of a borehole, conditions for production, and other demands of a customer, various types of pipe may be ordered and transported. Additionally, large quantities of pipe may be needed for relatively deeper wells. The large quantity and variety of tubular goods may result in logistical challenges in the OCTG industry. For example, manufacturers, distributors, and end users may all benefit from more efficient techniques for identifying and tracking pipe. Systems for efficiently identifying various attributes of a segment of pipe, and tracking its source, location, and destination may be developed to meet industry demands.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, an identification and tracking system includes a non-transitory tangible computer-readable storage medium having executable computer code stored thereon, the code comprising instructions that causes one or more processors to store a database comprising a plurality of pipe IDs and pipe information concerning one or more characteristics of the specific pipe, receive a query comprising a pipe ID, locate pipe information associated with the query, and display the pipe information.

In some embodiments, the pipe information includes pipe dimensions, pipe composition, pipe treatment details, pipe testing results, pipe order number, bill of lading number, pipe manufacturing location, pipe treatment location, pipe delivery destination, or combinations thereof. The system is configured to accept one or more identifiers each specific to a different pipe and display one or more pipe IDs, each associated with one of the one or more identifiers. The system may further include a scanner configured to communicate with the one or more processors and configured to scan the identifier of a pipe. Additionally, one or more of the processors may be configured to access the pipe ID from a remote database.

In another embodiment, a method includes reading an identifier of a pipe, sending a query to a database to access pipe information associated with the identifier, and displaying pipe information based on the identifier, in response to the query.

In some embodiments, reading the identifier includes reading an RFID tag on the pipe and displaying pipe information comprises displaying pipe dimensions, pipe composition, pipe treatment details, pipe testing results, pipe order number, bill of lading number, pipe manufacturing location, pipe treatment location, pipe delivery destination, or combinations thereof.

### BRIEF DESCRIPTION OF THE DRAWINGS

Embodiments of the present techniques are described with reference to the following figures. The same numbers are used throughout the figures to reference like features and components. Various embodiments may utilize elements and/or components other than those illustrated in the drawings, and some elements and/or components may not be present in various embodiments. Elements and/or components in the figures are not necessarily drawn to scale.

FIG. 1 is a schematic diagram of a tubular goods identification and tracking system;

FIG. 2 is a block diagram representing a method for implementing a system for identifying and tracking tubular goods;

FIG. 3 is another block diagram representing a method for accessing information and tracking tubular goods using the system;

FIG. 4 is a screenshot of a web application integrated with embodiments of the present techniques; and

FIGS. 5A-5C are screenshots of a mobile application integrated with embodiments of the present techniques.

FIGS. 6A-6C are screenshots of a mobile application integrated with embodiments of the present techniques.

### DETAILED DESCRIPTION

A large quantity and variety of tubular goods are produced, sold, and used in many industries, such as oil and gas, construction, water transport, automotive, agricultural, fluid power industries, etc. Identifying and tracking tubular goods throughout their manufacture, quality testing, shipment, and use may result in increased efficiencies and more accurate inventory control for manufacturers, deliverers, distributors, and end users of tubular goods. Tubular goods may refer to tubing, casing, drill pipe, line pipe, other OCTG products or American Society for Testing and Materials (ASTM) products, hollow structural sections (HSS), etc., and may be referred to as simply “pipe.” Tubular goods or pipe may include any tubular metal having a hollow cross section.

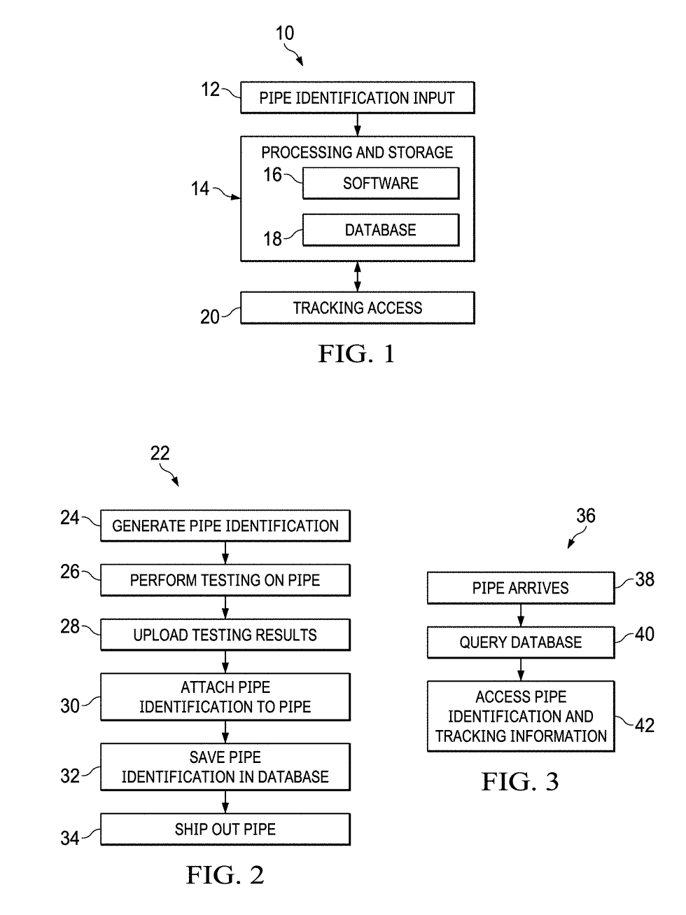

The schematic diagram of FIG. 1 includes components which may be used in a system for identifying and tracking tubular goods. Generally speaking, each pipe is assigned a unique pipe ID at or near the beginning of the manufacturing process, which is then associated with various items of pipe identification information and used to track each pipe and/or retrieve the associated pipe identification information, all of which is explained below in further detail.

FIG. 2 is a block diagram representing a method 22 for implementing a system for identifying and tracking tubular goods as they are manufactured. The method 22 begins with generating (block 24) a pipe identification (pipe ID) for a particular length of pipe. Generating (block 24) the pipe ID may occur while or around when the pipe is manufactured. The pipe ID may initially include a coil number, a batch or work order number, a pipe type, and/or the name of the plant in which the pipe has been manufactured. In one embodiment, a coil number may be input into an automated system which will then generate a new pipe ID each time steel is cut from the coil to form a new pipe. The pipe ID is entered into a database, where it is associated with various items of pipe identification information, as explained in more detail below.

As the pipe is manufactured, a barcode or other unique external identifier may also be applied to the pipe. The unique external identifier may be used to associate a particular pipe with its assigned pipe ID. In some embodiments, the unique external identifier may be used to identify a pipe during the manufacturing process, such that more information about the pipe may be properly input to the pipe's pipe ID.

For certain types of pipe, the unique external identifier may be in the form of an RFID tag, which may include a bar code or QR code, applied to the interior or exterior surface of the pipe. If an RFID tag is applied as the unique external identifier during the manufacturing process, the tag may be formed of a heat-resistant material to ensure that it is not damaged during the remaining portions of the manufacturing process or during its use in the field.

For certain types of pipe, the unique external identifier may be in the form of a stencil on the side of the pipe. In such an embodiment, the stencil may be replaced by an RFID tag, which may include a bar code or QR code, at or near the conclusion of the manufacturing process. For example, an RFID tag may be placed on the end cap which is affixed to the pipe before it is shipped out to a customer. In such an embodiment, other methods of applying a unique external identifier may be used when the end caps and RFID tags are removed from the pipe after it has been delivered to the customer. For example, laser etching may be used to apply a similar bar code or even simply to replicate the pipe ID similar to the stencil that was used during the manufacturing process.

The system 10 includes means for inputting (block 12) of pipe identification information. For example, pipe identification information may include a batch number, any associated sales order number, a location in which it was manufactured, tested, and/or treated, dimension information such as length, diameter, weight, material, and any other relevant information on the characteristics of the pipe. In addition, once a pipe has been manufactured and a pipe ID has been generated (block 24) for the pipe, various tests may be performed (block 26) on the pipe. For example, the pipe may undergo a hydrotester to test its performance under water pressure. Non-destructive testing (e.g., electromagnetic, ultrasonic, etc.) may also be performed to further assess the pipe's characteristics and quality and test it for defects. The results of this testing (block 26) may be added (block 28) to information associated with the pipe ID. For example, database 18 may include a copy of the Material Test Report (also sometimes referred to as the Mill Test Report) associated with each pipe ID. Pipe identification information may also include an indication of whether the pipe was rejected during testing or manufacturing and, if so, the reasons for such rejection.

Pipe identification information may also include historical information about the pipe, such as its date of manufacture and shipment, and intermediate shipment or treatment destinations. Pipe identification information may be input into system 10 using a graphical user interface (GUI) on a general purpose computer, a specially adapted terminal, or other similar means. For example, data entry stations and/or screens may be located at one or more stations within the steel mill, allowing an operator at each such station to enter additional pipe identification information. Alternatively, if an RFID tag is used as external identifier (as discussed in more detail below) sensors may be set up in combination with an RFID reader. In this way, a particular characteristic of a pipe may be automatically determined or measured and that value automatically input into the data and processing storage system 14, along with the external identifier for that particular pipe. As pipe identification information is input into processing and storage system 14, it is processed and organized by software 16 (e.g., associated with the relevant pipe ID) and saved to a database (e.g., database 18 from FIG. 1) that is configured to store pipe ID and accessible to external requests for pipe information.

Once the pipe has completed the manufacturing process, the pipe ID and/or unique external identifier may be used to track the pipe within the facility of the manufacturer. A pipe manufacturer's facility is generally referred to as a “yard” and these facilities can cover extremely large areas, which often creates difficulties in effectively managing, or even locating, inventory. For example, in an embodiment using RFID tags as the unique external identifier (whether on the pipe itself or on an end cap), RFID readers could be installed at various locations around the yard to create a “smart yard.” Forklifts may be equipped with RFID readers that are configured to scan the RFID tag on every pipe that is moved around the yard. In this way, the location of each pipe would be known from the time it leaves the mill at the end of the manufacturing process until the time it is shipped out to a customer. Such real-time information can be used to automatically create inventory maps showing the location of pipes all over the yard. Other similar methods could also be used, including workers using handheld scanners, drones equipped with RFID readers, or a myriad of other ways to track each pipe using its unique external identifier.

As part of this capability to track pipes within the manufacturer's yard, one embodiment of the present invention may include an internal mobile application. In addition to allowing pipe to be tracked by scanning the unique external identifier, the internal mobile application may allow the manufacturer and its employees to update pipe identification information even after a pipe has left the steel mill. For example, if a pipe had not previously been labeled with a unique external identifier, the internal mobile application may allow an employee of the manufacturer to retroactively associate that pipe with a pipe ID in order to have it included in database 18.

The present invention can also provide benefits for the manufacturer in connection with shipping of pipes. When a pipe is shipped (block 34) out of the manufacturing site, the identifier may be scanned to update the location of the pipe. For example, a scanner may be used to scan the RFID tag of a pipe to identify the pipe and update its pipe ID to include information about when the pipe has shipped out of a site, and where the pipe is destined to be delivered. In addition, scanning unique external identifiers may allow the manufacturer to automate certain aspects of the shipping process. For example, certain shipping forms that are commonly used in the industry are still typically completed by hand, which is a very time-consuming and inefficient process. The present invention may allow the manufacturer to enter a bill of lading number and then scan each pipe, such that the information can be used to auto-populate shipping forms and automatically calculate certain parameters such as total tonnage of the pipes included within a particular shipment. Scanning of each pipe's external identifier may also allow the manufacturer to automatically cross-reference the shipment with the customer's initial order, to ensure that the proper pipes are being shipped. Once the pipe had been shipped by the manufacturer and reached its destination, the pipe identification information may then be accessed (block 20) from the database 18, as shown in FIG. 3. For example, a distributor or end user may use a scanner or reader to scan or read an external identifier of a pipe. In some embodiments, the identifier may include a barcode, a radio-frequency identification (RFID), QR code, or any unique external identifier. The scanner or other device used to read the external identifier may be in communication with a remotely located processor used to store database 18. Such communication may be via a direct connection or wireless, such as using wi-fi or Bluetooth technology. Alternatively, mobile devices may be adapted such that scanning or reading the identifier may provide immediate access to pipe identification information of the scanned pipe. For example, an application or web portal may be saved on a mobile phone or laptop which may display the associated pipe identification information once a pipe is scanned.

A recipient may use an application or web portal from a computer, such as a mobile phone or laptop, which may be integrated with a scanner used to scan the pipe. Scanning the pipe may then allow a recipient to access pipe identification information and tracking information from the database 18, through the recipient's computer. Database 18 may be cloud-based to facilitate easy remote access by customers.

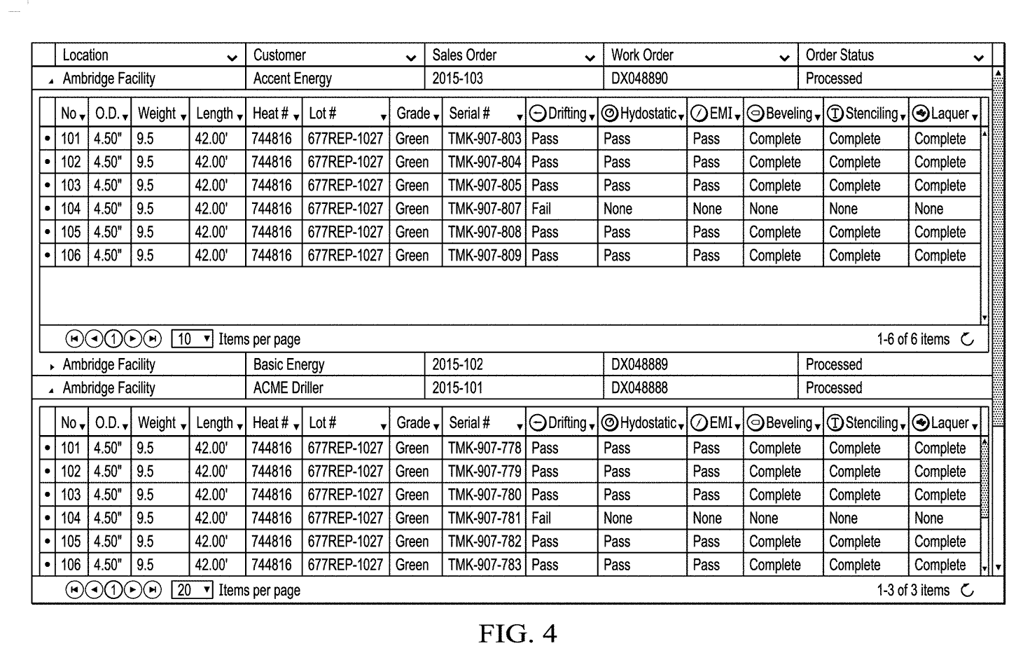

FIG. 4 is a screenshot of an example of a web application integrated with a system for identifying and tracking tubular goods. Several pipes may be scanned or read and simultaneously displayed with organized identification and historical information for each pipe.

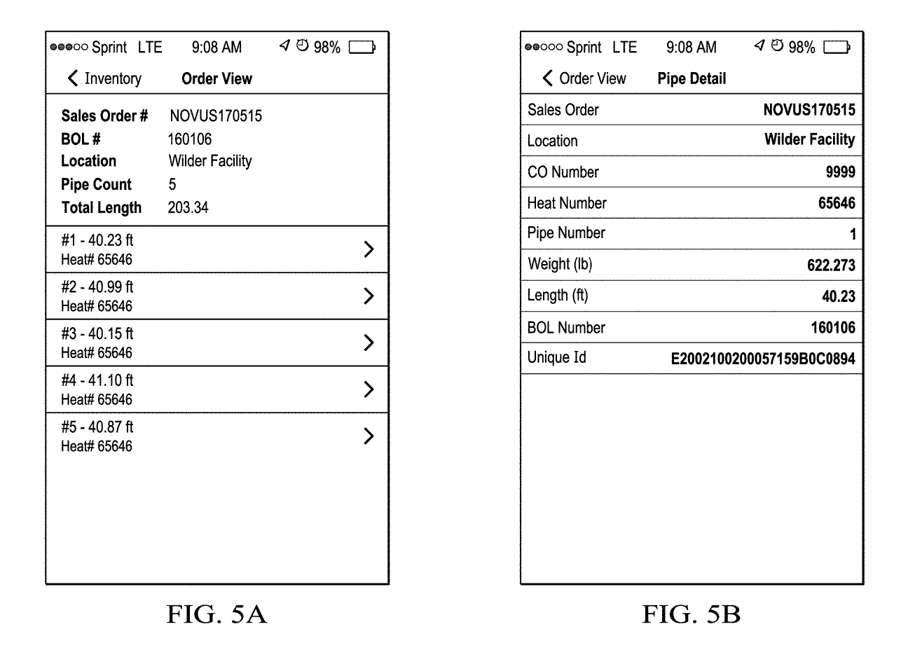

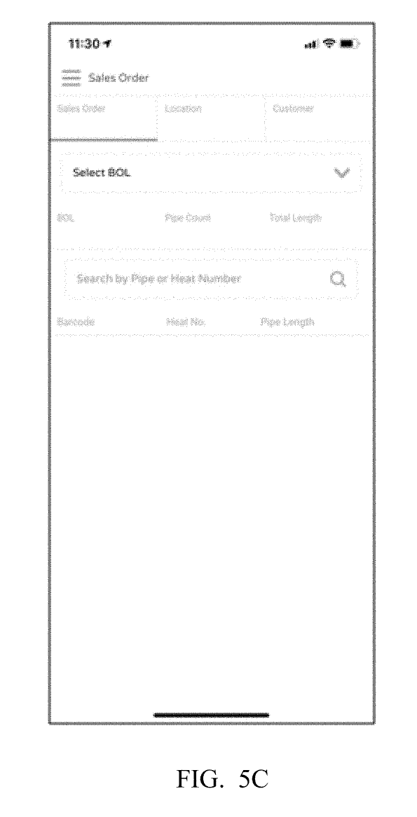

FIGS. 5A-5C are screenshots of a mobile application integrated with the present embodiments. As shown in FIG. 5A, in some embodiments, the pipe ID for several pipes may be displayed with adjustable levels of detail. Further information may also be displayed in detail for each pipe, as shown in FIG. 5B. As shown in FIG. 5C, there may be a higher level screen where the customer may select from among multiple orders before displaying information concerning individual pipes.

The web application and mobile application may each provide some combination of a number of characteristics associated with a pipe ID of each pipe. In some embodiments, the dimensions (length, weight, inner and/or outer diameters), processing data, testing data, heat treatment information, coil data (including material and composition of the pipe) may be displayed. Information related to the pipe's bill of lading (BOL) number, order number, and manufacturing and/or treatment locations and dates may be displayed.

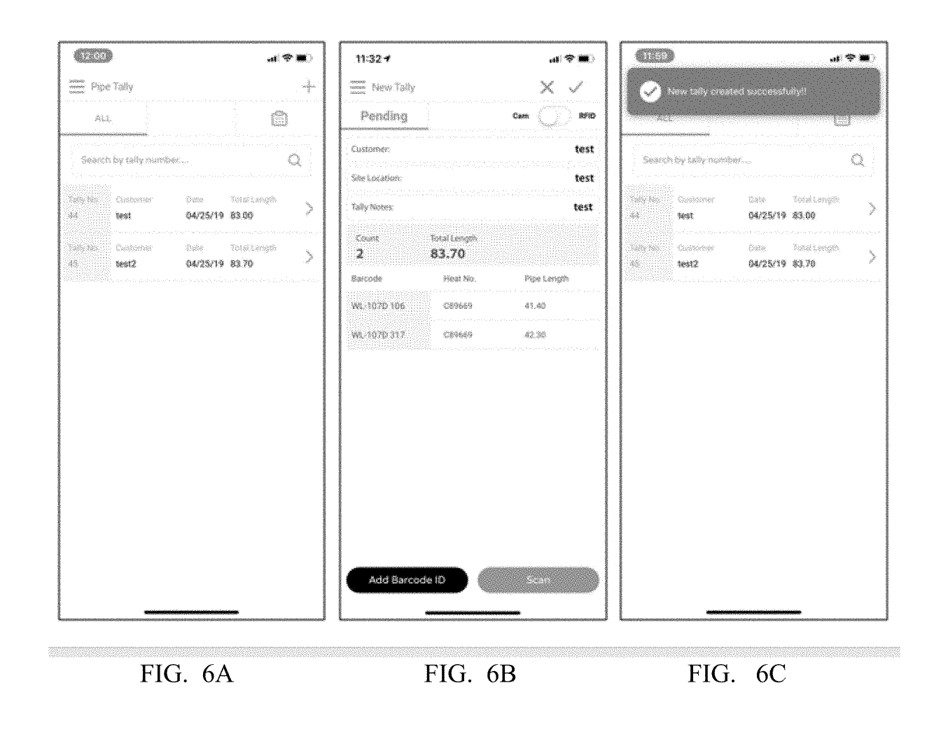

As one example, the web application and mobile application may allow customers to automatically calculate the overall length of a string of pipes by simply scanning the unique external identifier on each pipe. This is much more efficient than the current procedure of measuring each individual pipe by hand and adding up the total lengths. Examples of the screens used for this automated telling process are shown on FIGS. 6A-6C

Many modifications and other implementations set forth herein will be apparent having the benefit of the teachings presented in the foregoing descriptions and the associated drawings. Therefore, it is to be understood that the systems and methods described herein are not to be limited to the specific implementations disclosed and that modifications and other implementations are intended to be included within the scope of the appended claims. Although specific terms are employed herein, they are used in a generic and descriptive sense and not for purposes of limitation.

1. A system comprising:
a non-transitory tangible computer-readable storage medium having executable computer code stored thereon, the code comprising instructions that causes one or more processors to perform the following:
store a database comprising:
a plurality of pipe IDs, each pipe ID comprising an identifier unique to a specific pipe; and
for each pipe ID, pipe information concerning one or more characteristics of the specific pipe;
receive a query comprising a pipe ID;
within the database, locate pipe information associated with the query; and
display said pipe information.

2. The system of claim 1, wherein the pipe information comprises pipe dimensions, pipe composition, pipe treatment details, pipe testing results, pipe order number, bill of lading number, pipe manufacturing location, pipe treatment location, pipe delivery destination, or combinations thereof

3. The system of claim 1, further comprising a scanner configured to communicate with the one or more processors and configured to scan a pipe ID.

4. The system of claim 1, wherein the one or more processors is configured to access the pipe ID from a remote database.

5. A method comprising:
reading an identifier of a pipe;
sending a query to a database to access pipe information associated with the identifier; and
displaying pipe information based on the identifier, in response to the query.

6. The method of claim 5, wherein the step of reading the identifier comprises reading an RFID tag on the pipe.

7. The method of claim 5, wherein displaying pipe information comprises displaying pipe dimensions, pipe composition, pipe treatment details, pipe testing results, pipe order number, bill of lading number, pipe manufacturing location, pipe treatment location, pipe delivery destination, or combinations thereof.
